(19) United States
(12) Patent Application Publication
(10) Pub. No.: US 2024/0246788 A1
(43) Pub. Date: Jul. 25, 2024

(54) DEVICE FOR STORING, TRANSPORTING AND INSTALLING ELECTRICAL WIRES AND CABLES

(71) Applicant: NEXANS, Courbevoie (FR)

(72) Inventors: Christophe DEMULE, LAIZY (FR); Julien BRIN, SAINT BONNET DE MUR (FR)

(21) Appl. No.: 18/564,134

(22) PCT Filed: May 16, 2022
(86) PCT No.: PCT/FR2022/050925

§ 371 Date: Nov. 27, 2023

(30) Foreign Application Priority Data
May 31, 2021 (FR) FR2105706

(51) Int. Cl. B65H 49/38; B65H 49/20; B65H 75/18

(52) U.S. Cl. CPC B65H 49/38; B65H 49/205; B65H 75/182; B65H 2701/34

(57) ABSTRACT

The invention relates to a device (10) for storing, transporting and installing electrical wires or cables, comprising a base panel (12), a top panel (14) parallel to the base panel (12) and at least two attachment elements (16) connecting the base panel (12) to the top panel (14), at least one cylinder (18) on which an electrical wire or cable is wound, the cylinder (18) having a central space along the entire length thereof, this space receiving a rod having a predetermined geometric shape, which rod interlocks into a predetermined location in the base panel (12) and in the top panel (14), the cylinder (18) being rotatable about said rod.

The present invention relates to a device for storing, transporting and installing electrical wires and cables.

The invention belongs to the field of equipment for electrical wires and electrical cables in various sectors, such as construction or industry.

When an electrician is installing electrical wires, they sometimes find it difficult to unwind the wire from a coil, because the coil tends to move on the ground.

Moreover, the length of wire remaining inside the coil cannot be gauged directly, or even estimated easily.

Furthermore, once the packaging of a coil of wire has been opened, it is generally not easy to identify the value of the section of the wire other than by reading the data stated on the wire itself.

Moreover, when reels are used, it is generally necessary to have a dedicated tool per wire to unwind this wire. As many tools as wires are therefore required, which is not practical.

It is known practice to equip certain reels with an unwinder to facilitate the laying of the cables. It is also known practice to provide certain coils with a wire-guide.

However, at present, there is no device that simultaneously integrates the functions of storage, transport and installation for electrical wires or cables.

The present invention aims to overcome the above drawbacks found in the prior art.

To this end, the present invention proposes a device for storing, transporting and installing electrical wires or cables, which is remarkable in that it comprises a base panel, a top panel parallel to the base panel and at least two attachment elements connecting the base panel and the top panel, at least one cylinder on which an electrical wire or cable is wound, the cylinder having a central space over the entire length thereof, the space allowing a shaft of predetermined geometric shape to pass through, which shaft interlocks into a predetermined location in the base panel and in the top panel, the cylinder being rotatable about the aforementioned shaft.

Thus, the present invention covers, in a compact and very user-friendly way, all the functionalities of storage, transport and installation of electrical wires or cables. It saves time during installation, reduces the risks linked to handling, limits the scrap rate and has a reduced environmental footprint thanks to the sustainable nature of the transport and storage solution and because it facilitates garbage collection.

In a particular embodiment, the at least one cylinder has flat upper and lower faces indicating the value of the section of the wire or cable.

This provides immediate information on the section of the wire or cable without having to examine the wire or cable itself.

In a particular embodiment, the flat upper and lower faces indicate the value of the section of the wire or cable by color coding.

Color coding has the advantage of providing information that is directly understandable without translation and is clearly visible.

In a particular embodiment, the at least one cylinder is made of cardboard.

This helps reduce the environmental footprint of the device.

In a particular embodiment, the device further comprises a carrying case.

Thus, the device is protected against possible external attack due for example to bad weather and is practical to transport.

In a particular embodiment, the base panel and/or the top panel has, in the region of the predetermined location for interlocking of the aforementioned shaft, a series of marks indicating the remaining amount of wire or cable wound around the cylinder.

This provides immediate information, without the need for special handling, on the amount of wire or cable remaining.

In a particular embodiment, the base panel and/or the top panel comprises at least one wire-hooking eyelet adapted to receive one end of the wire or cable.

The end of the wire or cable is thus hooked neatly and this keeps it firmly wound around the cylinder.

In a particular embodiment, the device further comprises a carrying handle on the top panel.

This makes transporting the device even easier.

In a particular embodiment, the device further comprises a carrying shoulder strap on the base panel or on the top panel.

In combination with, or instead of, the carrying handle, this also makes transporting the device easier.

In a particular embodiment, the device further comprises at least one rod equipped with a wire-guide eyelet arranged on the base panel or on the top panel.

Passing the wire or cable through the wire-guide eyelet as it is unwound guarantees smooth unwinding of the wire or cable.

In a particular embodiment, the at least two attachment elements are attachment straps of adjustable length.

This makes it easy to adapt the height of the device to the height of the cylinders placed therein.

In a particular embodiment, the device further comprises a geolocation system.

This gives the user of the device the ability to track the location of the device, in case they leave it somewhere temporarily unattended, which can help prevent theft.

For the same purpose as that indicated above, the present invention also proposes a refill for a device as described succinctly above, which is remarkable in that it comprises a cylinder on which an electrical wire or cable is wound, the cylinder having a central space over the entire length thereof and having flat upper and lower faces indicating the value of the section of the wire or cable.

The particular features and the benefits of the refill are similar to those of the device and thus will not be repeated here.

### BRIEF DESCRIPTION OF THE DRAWINGS

Other aspects and advantages of the invention will emerge on reading the detailed description of particular embodiments set out below by way of absolutely non-limiting examples, with reference to the appended drawings, in which:

FIG. 1 schematically depicts a device according to the present invention, in a particular embodiment;

FIG. 2 schematically depicts a step of assembly of the device of FIG. 1;

FIG. 3 schematically depicts a device according to the present invention, in a particular embodiment in which it comprises a wire-guide system;

FIG. 4 schematically depicts part of the device of FIG. 1 showing a detail of implementation;

FIG. 5 schematically depicts a device according to the present invention, in a particular embodiment in which it comprises a wire-hooking eyelet.

### DESCRIPTION OF EMBODIMENT(S)

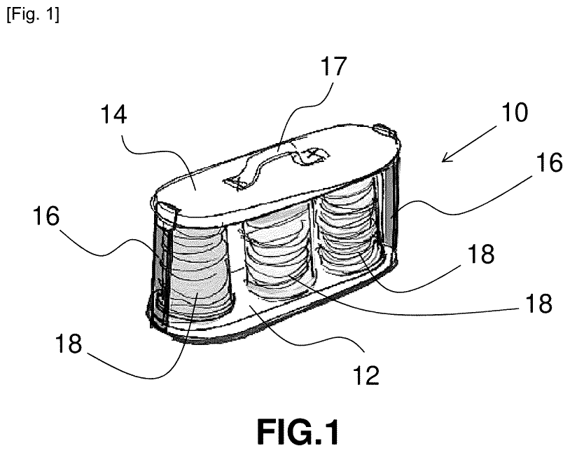

As shown in FIG. 1, in a particular embodiment, a device 10 for storing, transporting and installing electrical wires or cables according to the present invention comprises a base panel 12, a top panel 14 parallel to the base panel 12 and at least two attachment elements 16 connecting the base panel 12 and the top panel 14.

Moreover, the device 10 comprises one or more cylinders 18. An electrical wire or an electrical cable is wound on each cylinder 18 in such a way as to form a spool of wire or a spool of cable.

Optionally, the device 10 may also include a carrying handle 17 positioned on the top panel 14.

In a variant that has not been shown, in addition to or instead of the carrying handle 17, the device 10 may include a carrying shoulder strap, arranged on the base panel 12 or on the top panel 14.

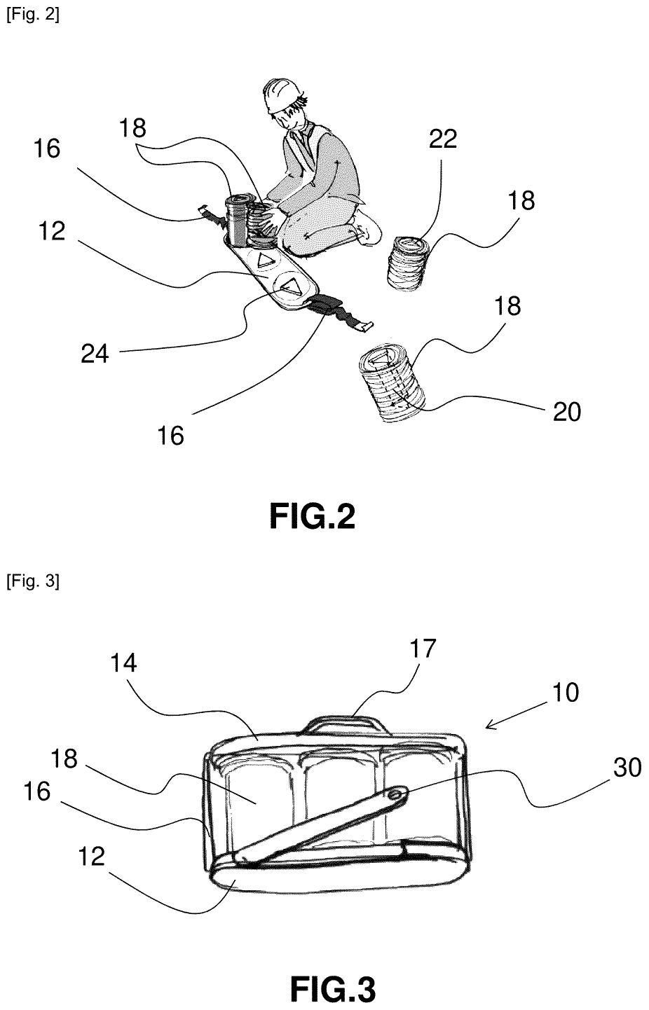

As shown in FIG. 2, each cylinder 18 has a central space 20 over the entire length thereof. This central space 20 allows a shaft 22 of predetermined geometric shape to pass through. By way of absolutely non-limiting example, FIG. 2 shows a shaft 22 having a triangular cross section. This shaft 22 interlocks into a predetermined location 24 in the base panel 12 and in the top panel 14. The cylinder 18 is rotatable about the shaft 22, thus allowing unwinding of the wire or cable which is wound around this cylinder 18.

Each cylinder 18 has flat lower and upper faces which, optionally, indicate the value of the section of the wire or cable wound around this cylinder 18.

By way of absolutely non-limiting example, color coding may be put in place such that a given section corresponds to a specific color. Thus, it is enough to look at what color the lower or upper face of the cylinder 18 is to know the section of the wire or cable which is wound around this cylinder 18.

Given that the cylinders 18 are positioned vertically in the device 10, one of the flat faces thereof is always visible and therefore makes it possible to identify the section of the wire or cable wound on each cylinder 18.

The cylinder 18 may be made of cardboard, preferably recyclable, or even recycled.

As can be seen in FIG. 2, in the particular embodiment shown, the two attachment elements 16 are attachment straps of adjustable length. However, this example is not limiting. Rigid attachment elements 16 may be provided.

Optionally, the device 10 may also include a carrying case (not shown) such as a bag, travel case or satchel, in which the assembly described above may be stored. This carrying case may have one or more external pockets for storing accessories, tools or any other small items of equipment or supplies.

As shown in FIG. 3, optionally, the device 10 may further comprise a wire-guide system, for example consisting of a rod attached to the base panel 12 or to the top panel 14, this rod having a wire-guide eyelet 30.

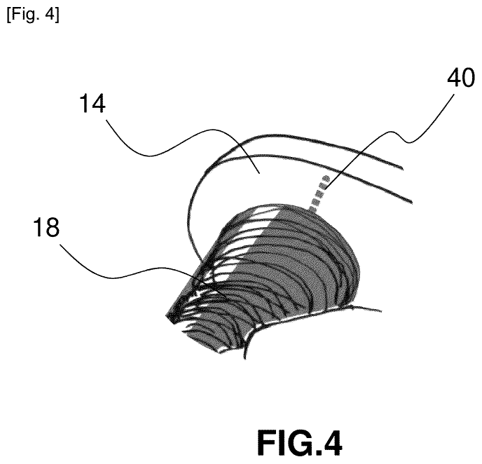

As shown in FIG. 4, the top panel 14 may have, in the region of the predetermined location 24 where the cylinder 18 interlocks into the panel, a series of marks 40 which indicate the remaining amount of wire or cable wound on the cylinder 18. These marks 40 may also be provided on the base panel 12. Thus, as the wire or cable is consumed, the cylinder will reveal new marks, indicating a lesser amount of available wire or cable remaining. By way of absolutely non-limiting example, it is possible to provide marks on one of the two panels 14, 12 indicating the remaining length for a wire with a section of 1.5 mm² and marks on the other panel indicating the remaining length for a wire with a section of 2.5 mm². Thus, the same system for reading the amount of wire remaining works for wires of two different sections.

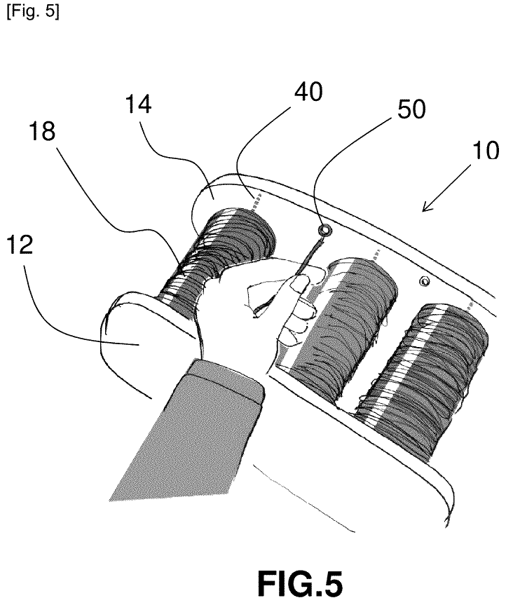

As shown in FIG. 5, optionally, the device 10 may further comprise, on the top panel 14 (as shown) and/or on the base panel 12, at least one wire-hooking eyelet 50 adapted to receive an end of the wire or cable wound on one of the cylinders 18.

Optionally, the device 10 may also be equipped with a geolocation system, for example of GPS type, known per se. Thus, the user of the device 10 may, for example by means of an application on their smartphone or other telecommunications terminal, check the geographical position of the device 10 at any time if they are not near the device.

Once empty, the cylinders 18 may be removed from the predetermined locations 24 and recycled if they are made of a recyclable material, whether cardboard or another material suitable for reuse. Refills, that is to say new cylinders 18 as described above, may then be interlocked into the predetermined locations 24.

In a cylinder 18 that has yet to be used, the wire or cable is for example covered with a plastic film on which the regulatory label is affixed.

The device 10 may hold a variable number of cylinders 18. In the particular embodiment shown it contains three, but as a variant space may be provided for five cylinders 18, for example.

1. A device for storing, transporting and installing electrical wires or cables, comprising:
a base panel,
a top panel parallel to said base panel and at least two attachment elements connecting said base panel and said top panel,
at least one cylinder on which an electrical wire or cable is wound, said cylinder having a central space over the entire length thereof, said space allowing a shaft of predetermined geometric shape to pass through, which shaft interlocks into a predetermined location in said base panel and in said top panel, said cylinder being rotatable about said shaft.

2. The device as claimed in claim 1, wherein said at least one cylinder has flat upper and lower faces indicating the value of the section of said wire or cable.

3. The device as claimed in claim 2, wherein said flat upper and lower faces indicate the value of the section of said wire or cable by color coding.

4. The device as claimed in claim 1, wherein said at least one cylinder is made of cardboard.

5. The device as claimed in claim 1, wherein said device further comprises a carrying case.

6. The device as claimed in claim 1, wherein said base panel and said top panel for interlocking of said shaft, a series of marks indicating the remaining amount of wire or cable wound around said cylinder.

7. The device as claimed in claim 1, wherein said base panel and/or said top panel comprises at least one wire-hooking eyelet adapted to receive one end of said wire or cable.

8. The device as claimed in claim 1, wherein said device further comprises a carrying handle on said top panel.

9. The device as claimed in claim 1, wherein said device further comprises a carrying shoulder strap on said base panel or on said top panel.

10. The device as claimed in claim 1, wherein said device further comprises at least one rod equipped with a wire-guide eyelet arranged on said base panel or on said top panel.

11. The device as claimed in claim 1, wherein said at least two attachment elements are attachment straps of adjustable length.

12. The device as claimed in claim 1, wherein said device further comprises a geolocation system.

13. A refill for a device as claimed in claim 1, wherein said device comprises a cylinder on which an electrical wire or cable is wound, said cylinder having a central space over the entire length thereof and having flat upper and lower faces indicating the value of the section of said wire or cable.

14. The refill as claimed in claim 13, wherein hat said flat upper and lower faces indicate the value of the section of said wire or cable by color coding.
